(19) United States
(12) Patent Application Publication
(10) Pub. No.: US 2006/0242137 A1
(43) Pub. Date: Oct. 26, 2006

(54) Full text search of schematized data

(75) Inventors: Divya S. Shah, Redmond, WA (US); Stephen Rosato, Woodinville, WA (US); Suresh Kannan, Bellevue, WA (US); Thomas A. Jeyaseelan, Kirkland, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/112,767

(22) Filed: Apr. 21, 2005

(51) Int. Cl. G06F 17/30

(52) U.S. Cl. 707/4

(57) ABSTRACT

Full text searching may be made available for resources stored in a database according to a database schema. A method for conducting a search on structured data using a text search engine includes the steps of: modeling a resource stored in a relational data store as a web page; providing a locator to the resource; and providing the resource in a consumable format to the text search engine. The method may include the additional steps of: receiving a search on the resource; converting the search into a converted query consumable by the search engine; and providing the converted query to the search engine.

### BACKGROUND OF THE INVENTION

1. Field of the Invention

The present invention is directed to a query format to search structured data, commonly provided in databases, using text-based search engines such as those commonly employed in World Wide Web based search engines.

2. Description of the Related Art

Content on the World Wide Web can be provided in many formats. The most common and familiar format is the Web Page, a collection of presentation coding and content that users interact with via a Web Browser. In many cases, the content and the presentation format of the page is stored with the page. However, in some cases, the data content of a web page may actually come from databases storing information in a defined schema and accessible through interface technologies. As is well-known, databases include information that is organized so that it can easily be accessed, managed, and updated. The most prevalent approach is the relational database, a tabular database in which data is defined so that it can be reorganized and accessed in a number of different ways.

Computer databases typically contain aggregations of data records or files. Structured Query Language (SQL) is a standard language for making interactive queries from and updating a database such Microsoft's Access, and database products from Oracle, Sybase, and Computer Associates.

Current search approaches to accessing schematized data use relational queries such as SQL to extract the data. However, as schemas grow richer and more complex, relational queries become difficult to use. This makes interaction with traditional search engines more difficult. Search engines are software programs that search information stores, and gather and report information that contains or is related to specified terms.

Search engines are used to gather and report information available on the Internet or a portion of the Internet. Crawler-based search engines create their listings automatically. They “crawl” or “spider” the web, then let the user who has issued the query review through what they have found.

FIG. 1 depicts a typical search engine provided in a processing environment 100 which accesses a plurality of sites having a number of pages 190a, 190b via the Internet.

Crawler-based search engines include the spider or crawler 142 which visits web pages of various web sites 190a, 190b to a list of URLs it maintains according to a priority defined by the spider's creator. For each page it encounters, the crawler reads the page, and follows links to other pages within the site. The spider returns to the site on a regular basis to look for changes. The crawler 142 takes a list of seed URLs as its input, and for each URL, determines the IP address of its host name, downloads the corresponding document, and extracts any links contained in it. For each of the extracted links, the spider adds it to the list of URLs to download. If desired, the spider process the downloaded document in other ways, such as adding it to a page cache 144.

The indexer 144 creates an index 146. The index 146, sometimes called the catalog, is a repository containing a key index of terms in every web page that the spider finds and the corresponding URL. The index is stored in a data store 150.

The search engine 152 sifts through the pages recorded in the index to find matches to a search and ranks them in order of relevance according to the engine's ranking algorithm. The query can be quite simple, a single word at minimum, or more complex, with words or phrases joined by Boolean operators to refine and extend the terms of the search.

Generally the search engine 152 operates in response to a request from a user via a user agent, such as a web browser 156 on a processing device 125. A web server 154 provides a search interface, including a keyword entry form, to the user. When a user on a client based user agent, such as a web browser 156, seeks to provide a search query to the information stored in the data store 150, the user will enter their search in the interface provided in the web browser 156 by the query server 154 which will be provided to the search engine 152. The user may enter key words connected by logical operators such as “and,” and “or” which will be used by the search 152 to query the index 106 and retrieve the information according to a ranking system utilized by the search engine 150. The results will be returned by the search engine 152 to the query server, which will then present the results and one of any number of multiple formats to the client web browser 156.

Results may be provided as a page title and URL, or richer results may be shown. For example, the search engine results may include a snippet of page text (or portions of text highlighted showing the search terms from the original page) along with a link to the original page, and/or a link to a cached page stored in page cache 148. It will be recognized that there are many different variations on how search engines retrieve and display information.

Crawlers generally cannot interact with pages including data from a relational data store. That is, the information stored in the page cannot be indexed by the indexer 144. When a web browser 146 seeks to interact with site 192 which includes pages which retrieve information from a relational data store 180, a query engine 170 and rendering engine 160 are utilized to generate the pages 192 for provision to the web browser 116. The page request, whether a query entered into a web page 192 or other call for a page with data, is provided to the query engine 170 which converts the query into a relational query using, for example, structured query language. The store returns the information to the rendering engine which converts this information into HTML or other text which can be rendered into a page 192.

Problems arise in the configuration shown in FIG. 1 when the data store 180 is spread over multiple relational databases on multiple physical servers. This means that the query engine 170 must query different numbers of servers, with each server possibly being at a different level of update relative to other servers in the processing environment 130.

It would therefore be useful to allow use of a search engine in processing environment 100 to access the data store 180 and the information contained therein. Structured data may be provided in other formats as well. It would be desirable to allow use of a search engine to conduct text based searching of multiple types or sources of structured data.

### SUMMARY OF THE INVENTION

Full text searching may be made available for resources stored in a database according to a database schema. The resources represented in a database schema are modeled as documents and full text queries can be performed against the data using standard text searching technology.

The invention roughly described, comprises a method for conducting a search on structured data using a text search engine. In one embodiment, the method includes the steps of: modeling a resource stored in a relational data store as a web page; providing a locator to the resource; and providing the resource in a consumable format to the text search engine.

In another embodiment, the method may include the additional steps of: receiving a search on the resource; converting the search into a converted query consumable by the search engine; and providing the converted query to the search engine.

In another embodiment, the invention is a method for rendering structured data searchable using a text search engine. In this embodiment, the method includes the steps of: determining a modified resource in a data store; creating a uniform resource locator for the modified resource; providing the URL to a search crawler; and generating a text representation of the resource in response to a query from the search crawler.

In yet anther embodiment, the invention is a method for providing key word searching of structured data. IN this embodiment, the method includes the steps of: determining a set of modified resources in a data store; creating a uniform resource locators for the set of modified resources; providing the uniform resource locators to a search crawler; generating a text representation of the resource in response to a query from the search crawler; receiving a search query result from the search engine; and rendering a presentation of the query result to a user interface.

The present invention can be accomplished using hardware, software, or a combination of both hardware and software. The software used for the present invention is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers.

The objects and advantages of the present invention will appear more clearly from the following description in which the preferred embodiment of the invention has been set forth in conjunction with the drawings.

### BRIEF DESCRIPTION OF THE DRAWINGS

FIG. 1 is a depiction of users interaction with a processing environment including a search engine and a processing environment housing a relational data store interacting in accordance with the prior art.

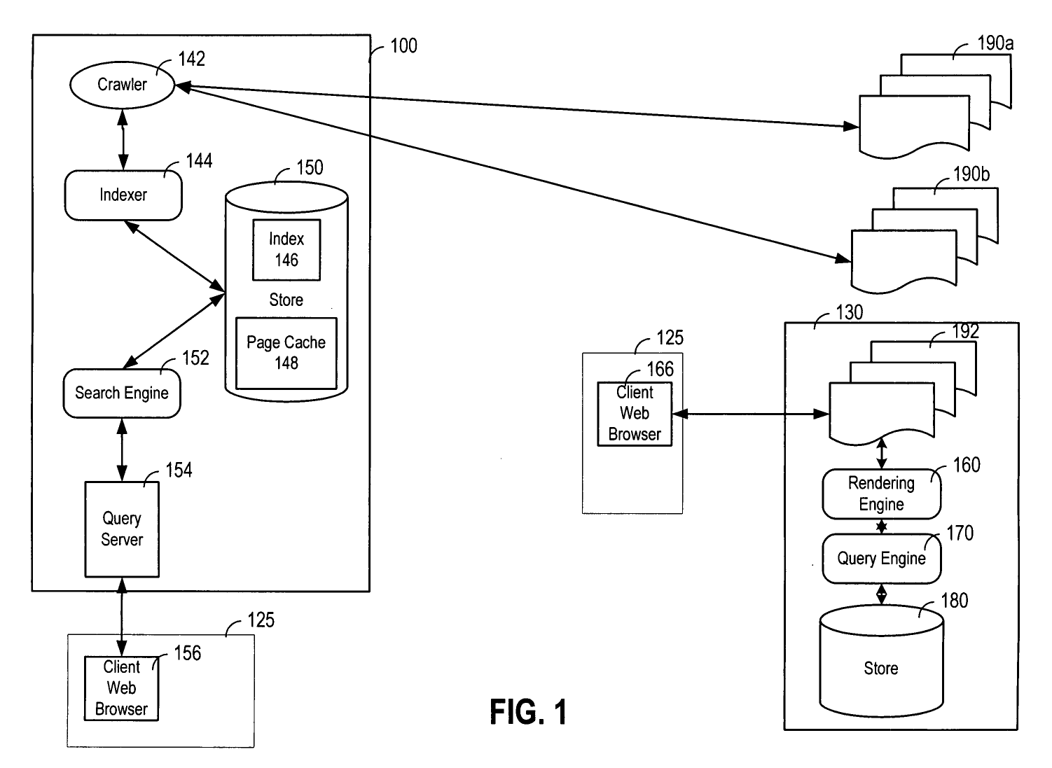

FIG. 2a is first embodiment of a method for implementing the present invention.

FIG. 2b is a second embodiment of a method for implementing the present invention.

FIG. 3 is an embodiment for implementing a search in accordance with the present invention.

FIG. 4 is an exemplary results page for a search query implemented in accordance with the present invention.

FIG. 5 is a block diagram depicting a system for implementing the present invention.

FIG. 6 is a depiction of a user interface for conducting a search via a web browser utilizing the system and method of the present invention.

FIG. 7 is a depiction of a user interface displaying search results provided by the system and method of the present invention.

FIG. 8 is a depiction of a user interface for adding meta tags to user information in accordance with one embodiment of the present invention.

FIG. 9 is a depiction of a user interface for implementing a second type of search in accordance with the system and method of the present invention.

FIG. 10 is a depiction of a user interface showing search results of a search conducting in accordance with the input provided in FIG. 6.

FIG. 11 is a depiction of a processing environment suitable for use in accordance with any of the servers or computers described in this application.

### DETAILED DESCRIPTION

The invention models the resources represented in a structured fashion, such as a relational database schema, as documents and enables full text queries to be performed against the schema using standard text searching technology. Specifically, the system creates a URL that represents a particular resource in a schematized store, and provides access to the resource when a search engine crawls the URL or information associated with the URL is requested by a user. In accordance with a search engine's operation, the URLs are listed in the engine's store of pages to be crawled. When the search engine crawls the store, new and changed URLs are crawled; URLs not modified since the last crawl are not crawled. To model a logical resource as a document, property values of the resource are canonicalized, such that field values are translated into specific IDs. When a search is performed, the search result brings back the document plus sufficient information to create a search results page for the user. While the invention is described with respect to stored data, the invention can be used to provide a query service to any data which can be constructed by a logical operation such as an algorithm or structured lookup. References to a “store” of data should be understood as referring to persistent and non-persistent data represented logically in accordance with the present invention.

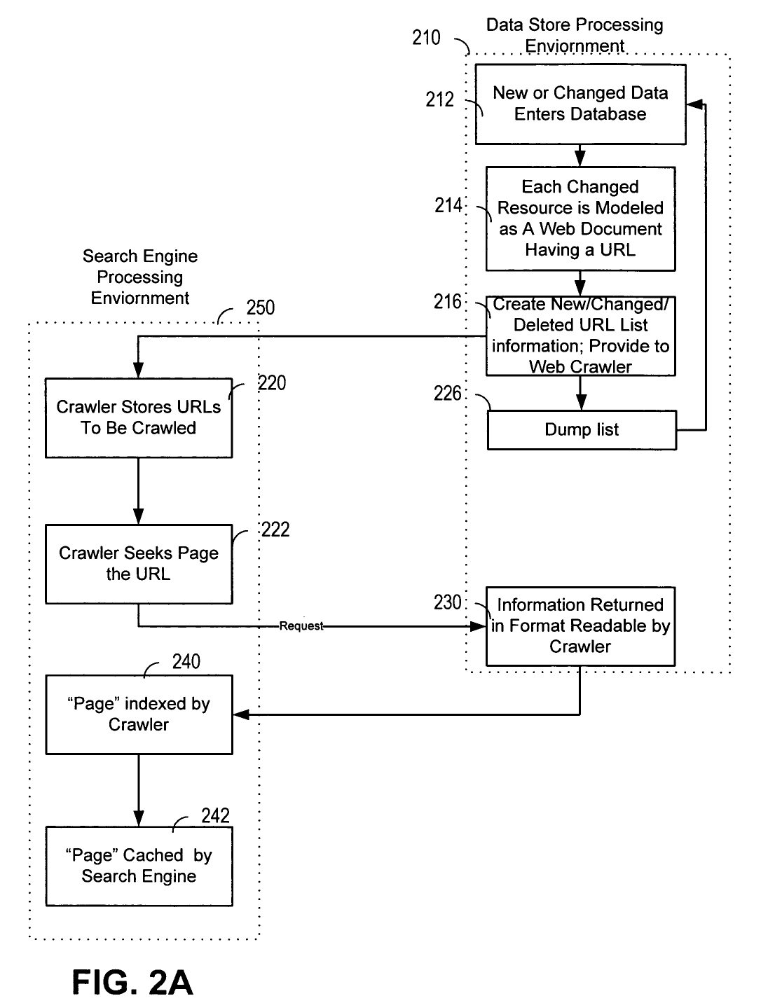

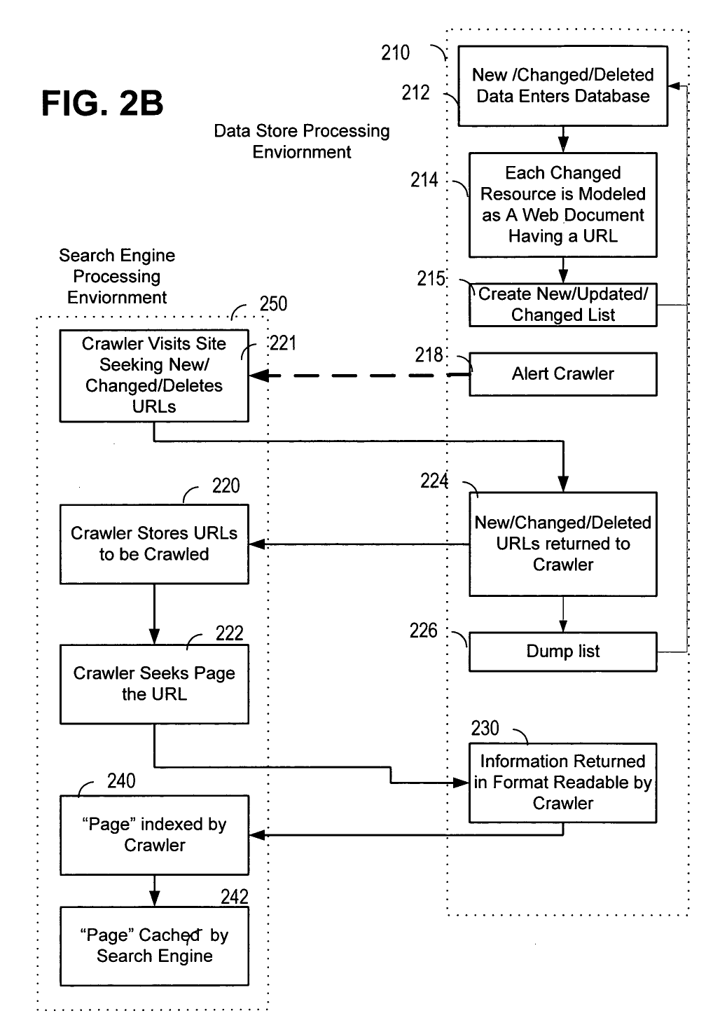

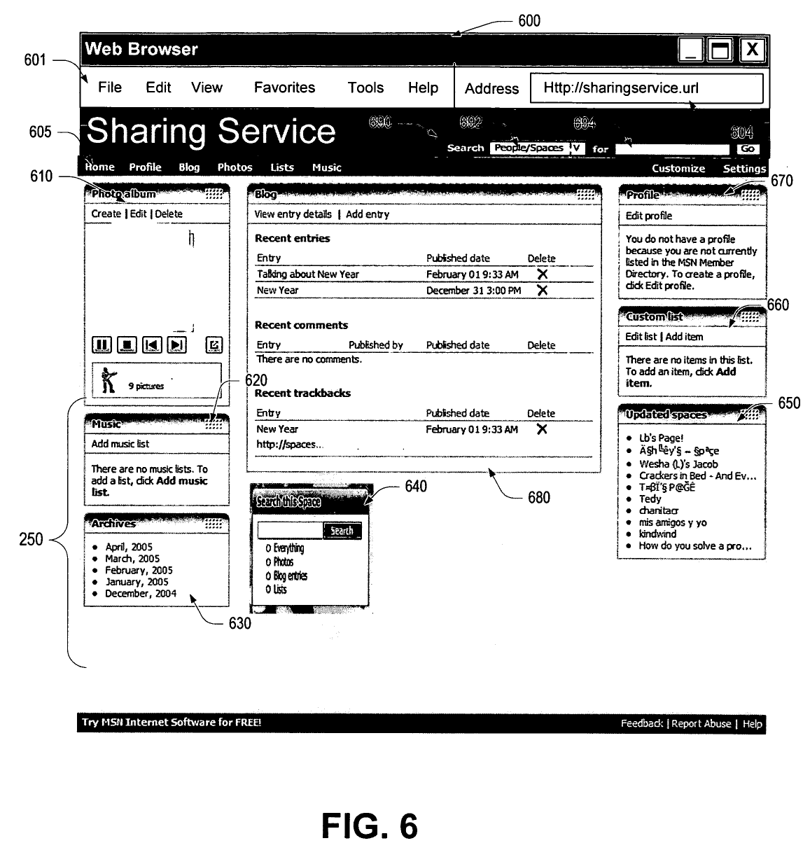

FIG. 2a is a first method for enabling full text search of synthesized data in accordance with the method of the present invention. For purposes of illustration, the method and system described herein will be discussed in relation to its use with relational data which is used in a “sharing” system. The sharing system allows the user to publish information to one or more web pages which are accessible to other users, or the public as a whole. The sharing system may be provided within a trusted computing environment in which users are required to create user accounts and authenticate themselves to the trusted computing environment. One example of such a system is MSN® Spaces (spaces.msn.com). The content stored in the sharing environment can be stored on file servers, and organized using a relational data store so that information about the content can be quickly retrieved and provided to other users. Examples of content within the sharing service include pictures, documents, weblog entries, and a user profile. The sharing store may allow the user to create meta-data information associated with the content. In a profile, for example, the user can indicate geographic location and the user's interests. In a picture, the user may annotate the picture with keywords identifying the subject matter of the picture. In the present example, it would be advantageous to allow users within the trusted computing environment to search for and receive search results on users having similar interests, or specified criteria, using a standard search system interface. As shown and described below, users can set permissions for their space so that anyone on the internet or only people who have accounts with the trusted computing environment and whom the user chooses, can view the sharing content. Information that users publish to the sharing environment can be presented to a user interface in units called modules which contain content information and links to user provided material. These are discussed further with respect to FIG. 6.

It will however be recognized that the usefulness of the system and method of the present invention is not limited to a sharing environment. Any system wherein a need to provide access to data provided in a schematized data store utilizing standard internet based search engine would benefit from the present invention. In addition, it will be recognized that the usefulness of the present invention is not limited to databases. The invention can be used to provide a query service to any data which can be constructed by a logical operation such as an algorithm or structured lookup.

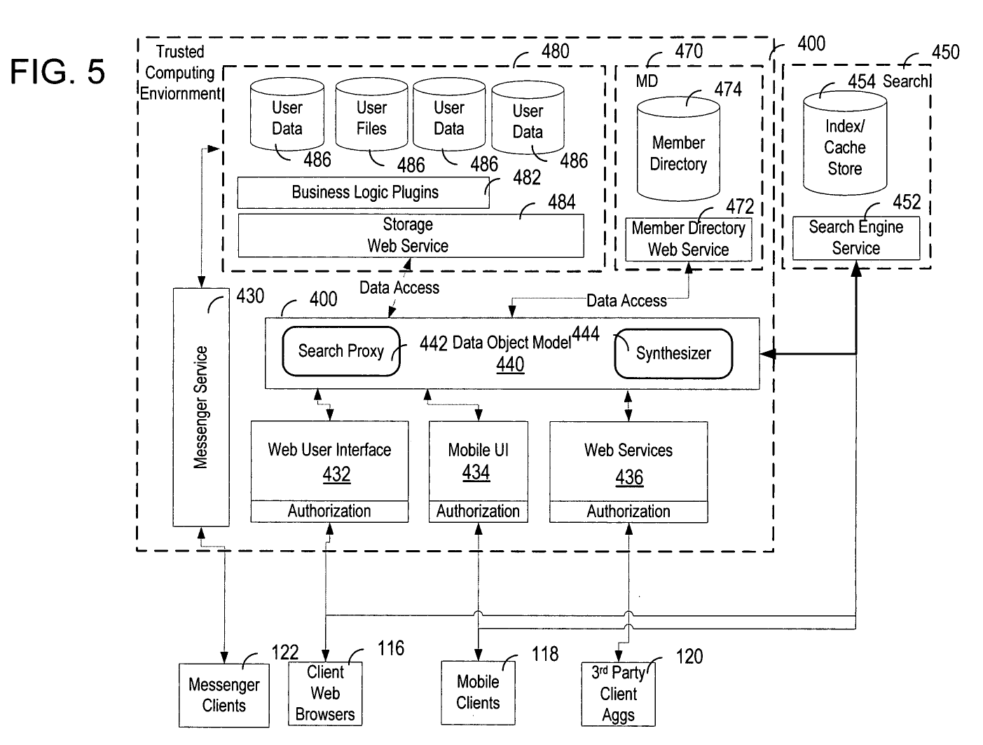

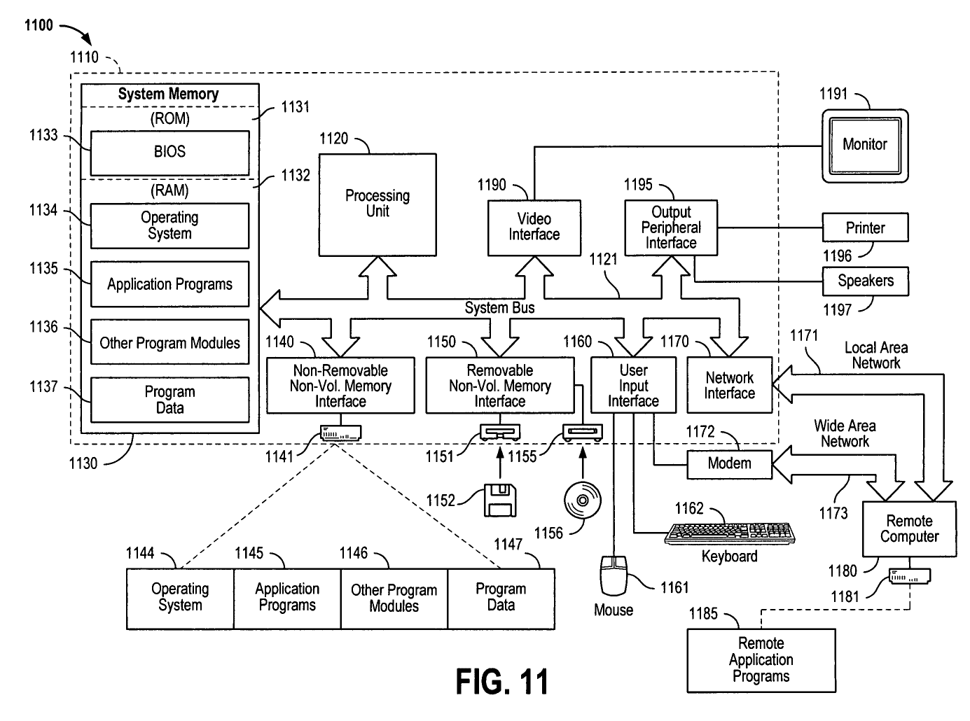

FIG. 2a shows method 200 in the context of its operation on two different processing or computing environments 215, 250. It will be understood by one of average skill in the art that the methods discussed herein my be implemented by code for instructing one or more processing devices to perform the methods on the one or more devices, or collection of devices, described herein. One example of a processing device is described with respect to FIG. 11 and a system of devices and resources for performing the methods described with respect to FIG. 5. A data store processing environment 210 includes one or more processing devices, computers, servers, etc. which include code instructing the processing environment perform steps of the method illustrated in the context of the data store processing environment 210. Likewise, search engine processing environment 215 includes one or more processing devices, computers, or servers including code instructing the processing environment to perform the steps specified in processing environment 250.

Initially, the method of FIG. 2a begins when new or changed data provided by the user is entered into a relational data store, such as data store 180, in an environment which is accessible to the internet. The modified information may be: new data, such as additions to a sharing environment, or the creation of a new sharing environment; changed data, such as annotations to data in a sharing environment or modifications to a user profile; or deletions, including deleting an entire sharing environment or deleting objects in the sharing environment. When data in the data store is changed, at step 214 the changed resource is modeled as a web document with a uniform resource locator (URL). The logical resource modeled will depend on the schema of the relational database modeled. In the sharing environment example, types of data—pictures, web logs, profiles, lists, etc.—can each be a resource. In this context, each item or data object as defined by the database schema can be defined as a resource, or a group of objects such as a profile or sharing space can be defined as a resource. Where each object is defined as a resource, a group of resources defines a space or profile. The URL created at step 214 can be created in a number of ways. In one alternative, the URL comprises a unique identifier for a sharing environment, or object in the sharing environment, identified with a particular user. In alternative embodiments, information about the data which has been changed in step 212 is encoded into the URL which is generated at step 214.

At step 216, a process in the data store processing environment 210 provides the new, changed, or deleted URL information for the logical pages to the search engine processing environment 250. Following step 216, the list can be flushed at step 226 and a new list started. In FIG. 2a, step 216 is performed by providing the search engine processing environment with one or more update files which can be consumed by the crawler operating the processing environment 250. In one embodiment, two files are used: an add file and a deleted file. An add file contains a list of URLs that the processing environment 250 is required to navigate to and which the processing environment 250 will index for content. This add file is a list of new and changed URLs. To the processing environment 250, the list is a series of pages which its crawler is prepared to go out, crawl and index. However, as will be more fully explained below, no actual viewable pages have been generated by the data store processing environment 210. A second file may be provided with a list of URLs that the processing environment should not consider in its index, this file may be generally termed a delete file and provides a way to remove URLs previously added through the add file. This allows deleted posts to be removed from the processing environment 250 index. In one embodiment, both files are generated concurrently or combined in a single file. In the embodiment of FIG. 2a, this push of the file information at step 216 can occur on a regular or semi-regular basis. In one embodiment the change information is pushed to the search engine daily, or every 7-8 hours, or at some other regular or irregular interval.

Once the processing environment 250 receives the add, change, and delete information at step 220, the crawler stores the URLs provided in the two files, and at step 222 begins its page crawl process by seeking the page identified with the URL listed in the file provided at step 220. When a request for the page is received at step 230 by the data processing environment 210, a rendering engine in the data store processing environment will retrieve the information from the relational data store and return the information from the data store in a format which is readable by the crawling process.

FIG. 2b shows a second embodiment of the method of the present invention. In this embodiment, steps which have the same numbers as those indicated in FIG. 2a are equivalent to those in FIG. 2a. In the embodiment in FIG. 2b, instead of pushing information out to the search engine processing environment 250, the data store processing environment 210 either waits for the normal crawler visit or initiates a crawler visit. In the embodiment of FIG. 2b, after each change occurs, a list of add/changes 215 is created in the data processing environment 210 Data processing environment 210 continues this process until the crawler visit. The crawler visit can be initiated by the data processing environment 210 at step 218 or by simply waiting for the next visit of the search engine processing environment 250. At step 221, the crawler in processing environment 250 will attempt to visit the changed and new URLs which it has been determined from step 214. At step 224, the new and changed URLs are returned to the crawler. At steps 220, 222, 230, 240, 242, the method of FIG. 2b operated in the same manner discussed above with respect to FIG. 2a, whereby the crawler stores the URLs at 220, seeks out those pages identified at step 222, indexes the information of the resources at step 240, and optionally stores a cached version of the page at step 242. When the crawler seeks the information at step 232, the information is returned in a format readable to the crawler at step 230 by the information processing environment 210.

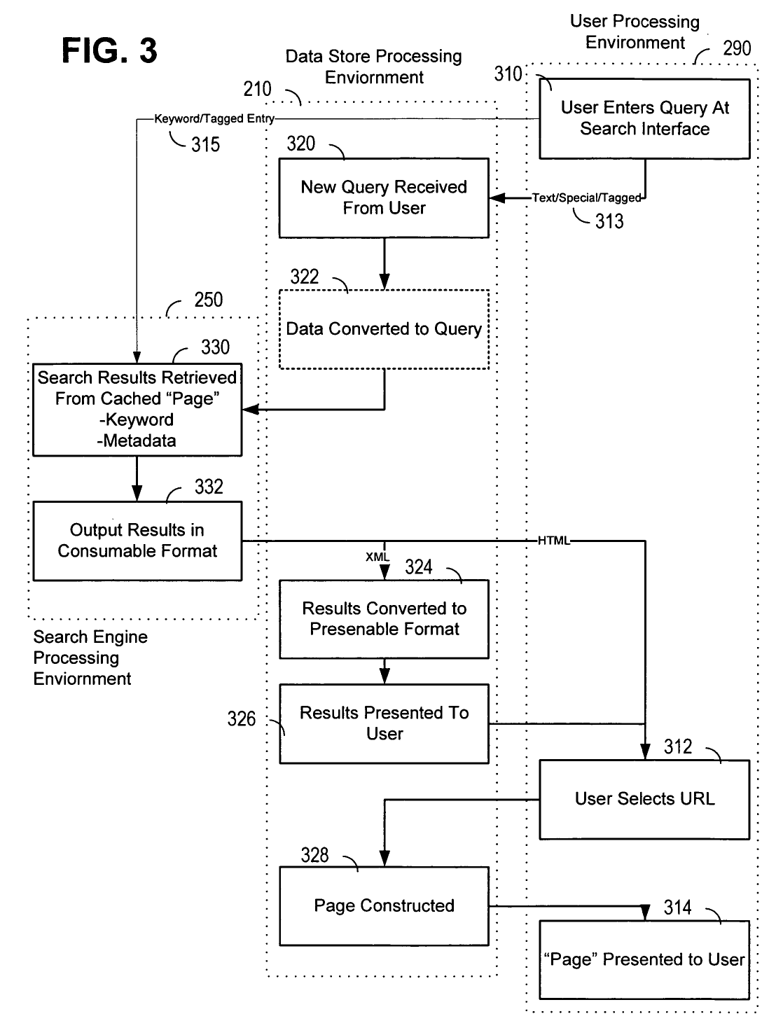

In both of the above embodiments, at step 230, every logical resource in the schematized store is modeled as a document that the search engine can crawl and index. In the sharing system discussed above, if the individual user decides to share a profile, that profile may be modeled as a document. When the data store returns a document for any resources that were newly created or modified, the data store actually outputs every page, object, and field as a separate unique HTML file that the search engine can crawl. Pages are not necessarily real or viewable public pages, but are built on the fly and for the instance that the item is being crawled. In the embodiment shown in FIG. 3, when a search is run against the search engine, the engine query is run against this index and cache of unique HTML pages. The HTML format used need not be a user-optimized format, but only information which may be indexed by the crawler and used by the search engine. As a result, at step 240 the search engine processing environment will index the page. Optionally, at step 242, a cached version of the page may be stored.

In a further embodiment of the invention, step 212 (of either the embodiment of FIG. 2a or 2b) need not be changed data, but may comprise a “snapshot” file comprising the current state of the data store. Such a file would comprise a full list of all objects that exist in the database, and the search engine can be instructed to delete its existing store and process this snapshot file.

In order to model the resource as a document, property values of the resource are, in one embodiment, canonicalized and made unique. This information can be used when a search is conducted to support localization and range based searching, discussed further below.

Another portion of the data which may be included in the resource document, and which may be returned at step 230, includes data object tags. Object tags are unique identifiers in specified fields which may be pre-defined by the data processing environment administrator of defined by the user to identify the resources in the data store and make them easier to search. As discussed below, users are given the option to tag elements in their shared space with a classification identifier or tag. The method of the present invention supports both tag searching and free text key word searching as shown in FIG. 3.

FIG. 3 shows the method of the present invention which occurs when a user initiates a search in the user's processing environment against the information in a database having data stored in a schema. At step 310, the user enters a query at the search interface. The may comprise a key word search 315, or a more focused, specialized search on the object tags described above. The query may be entered via an interface provided by the data store processing environment 210 or by the search engine processing environment 250. The data store processing environment 210 supports keyword, special and tagged searching 313. Alternatively, a query 315 may be directed to the search engine directly. The specialized search 313, may, for example, be through an interface provided by the data processing environment 210 with particular functionality to assist a user in searching for object tags or other criteria which is provided by the data store processing environment which are unique to the data store. Examples of this are shown below in FIGS. 6 through 10.

If the search is received by the data store processing environment at step 320, the search may optionally be converted at step 322 into a query that the search engine processing environment can understand. Conversion may be utilized in the example of the sharing environment, where property values of the resource such as a user profile are canonicalized. This information can be used when a search is conducted to support localization and range based searching. In the canonicalization process, properties in a profile such as the interest of a person are translated into a unique identifier in a defined taxonomy. For example, an interest in sports may be reflected CATID_{—}5434 in the HTML document. A further example is shown is shown below:
FNAMEID_Klein LNAMEID_Biker NICKID_klein1469 GENDERID_F AGERANGEID_Over70 CATID_{—}28 CATID_{—}50 CATID_{—}109 CATID_{—}119
   Where:

FNAMEID is the user's first name;

LNAMEID is the user's last name;

NICKID is the user's username;

GENDERID=F indicates the users is female;

AGERANGEID is the user's age range bucket; and

And CATTDs are canonicalized codes indicating the user's interests

Localization allows language independent queries on the data. For example, a search on CATID_{—}5434 in any language will return an interest in sports in a profile search. Queries submitted to the data processing environment in the local language are compared against the taxonomy and submitted to the search engine as the unique identifier for the interest.

Typically, search engine support for range queries is generally not provided. That is, one cannot use the search engine to query the index for a given range of items. Hence, if a user wished to know, for example, all users within a certain age range who like basketball, a typical search engine cannot make a range query. The example of an age search is complicated if the data only exposes a year as opposed to an age. In this case the underlying query is “show all users having birthdays between two different dates.” Most search engines only look for the occurrence of a string. Using the canonicalized values, individual age ranges or ages can be encoded into user profiles. Range searches can be implemented by converting a range query (with some pre-defined syntax provided by the data processing environment or, say, a drop down menu of pre-selected ranges) into a string of values. Alternatively, age ranges may be segregated into discrete range buckets, queries made specifically on each bucket range. Canonicalization also provides value uniqueness. This insures that the uniqueness of values in the data store avoids conflicts with values in other parts of the document.

If canonicalized items are represented in the query, these can be converted to key terms by the data environment at step 320 In another example, range searches can be converted to queries for discrete items within the range (such as, for example, ages in buckets). Alternatively, object tags can be entered directly into the search interface and provided directly via query 310 to the search engine processing environment 250. At step 330, once the search processing environment has received the search query, search results are retrieved from the index based on the input via search 313 or search 315. Hence, a query is for data in data store 180 can be run against the index. At step 332, results from the search engine's query of its own index are returned and output in a consumable format.

In one embodiment, the consumable format may be a web page presented in HTML for consumption by a user agent, such as a web browser in the user processing environment. Other http clients or user agents are suitable for use with the present invention. In an alternative embodiment, the format consumable format is XML for consumption by the data processing environment. At step 324, the data store processing environment can consume the XML and convert the XML into a presentable format. It will be recognized that the results presented will generally be a list of pages and URLs which were originally consumed by the search engine at step 240, and may additionally include other information to generate a “snippet” in the presentation of the results back to the user. At step 326, the results presented back to the user by a rendering process operating on the data store processing environment 210. This process can include retrieving additional or original snippet information from the original data store, and presenting it back to the user in a format the user can understand.

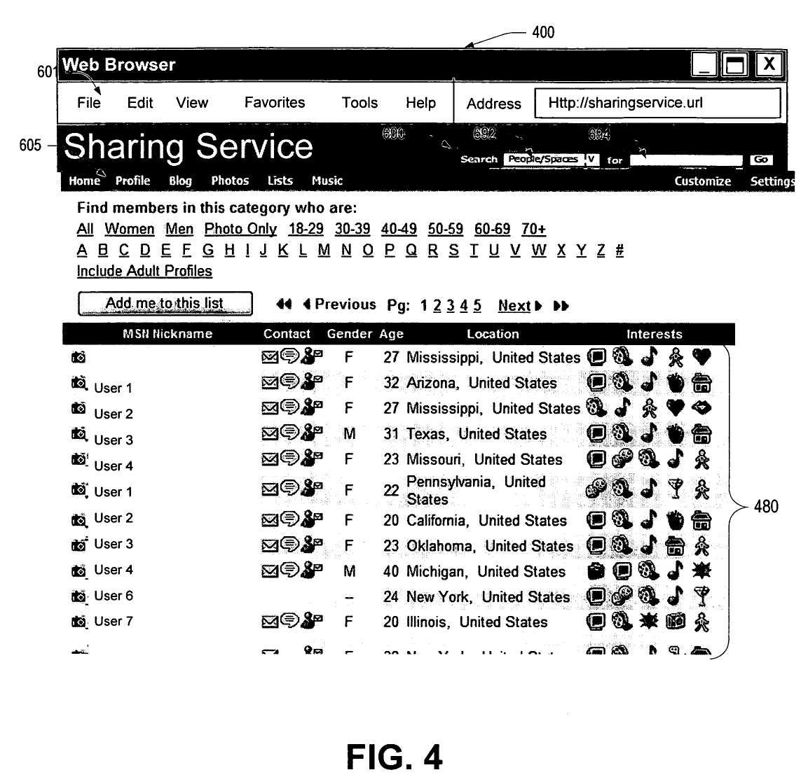

FIG. 4 shows an example of the output of the search results provided at step 326. In this example, the results were for a search of user profile information in a sharing service, and the list 480 is a list of users having, for example, profiles reflecting a common interest in movies. In FIG. 4, the results are shown in exemplary user interface 400 implemented in a web browser for sharing service such as that described above. Web browser 601 includes a standard menu of information tools that are accessible to the user of the web browser, including an address line 604 for allowing the user to enter the uniform resource locator of the sharing service. The sharing service interface includes a menu 605 which allows users of the sharing service to access various components of the service. This interface is detailed further below. In this example, nickname, contact, gender, age, location, and interests are called to be displayed in a collection view. The displayed information returned on each search hit typically includes the resource URL, title, and a “snippet.” The search engine snippet generation algorithm may be different for different search engine environments and hence cannot be relied upon to provide the information needed to render the collection view shown in FIG. 4. Different engines compute snippets differently and the system and method should ensure that all the data needed for generation will be returned to the engine.

In one embodiment, the results obtained from the search engine are sufficient to render such a view directly from the search engine index, without having to subsequently hit the underlying profile store. This alternative involves encoding certain types of data into the URL itself. In this case, where the user has performed a search for all other users having sharing spaces dedicated to basketball, a URL indicating a profile interest in basketball can be encoded into the URL itself. In such case, the conversion of results are presented by format at step 324 may be directed to a specific resource within the relational data store 180 to extract specific information from the relational data store, rather than having to retrieve the entire sharing space or profile of a particular user.

An exemplary encoded URL will may appear as follows:

http://examplesharingdomain.com/?mpp=4263&FN=Klein&LN=Biker&NC=klein 1469&GN=F&CN=4&ST=12&AR=8&CT=28,50,109,119,172,176,178,266,316,349

Where:

FN is the user's first name;

LN is the user's last name;

NC is the user's username;

GN=F indicates the users is female;

CN is the user's country;

ST is the user's state;

AR is the user's age range bucket; and

CT are canonicalized codes indicating the user's interests.

In the second alternative, the engine provides the resource identifier (URL) in XML to the data processing environment 210, and step 324 comprises a second query to the relational database for nickname, contact, gender, age, location, and interests information In this embodiment, the results provided at 322 are simply a sharing space identifier or profile identifier for a user. In the example where a search for profiles of all users interested in “basketball” is used, the results returned at step 332 may simply be the URL for a page to a user having a profile which was indexed at step 240 as indicating the user's interest in basketball. In this case, basketball may appear some number of times on the user's page, or the page may be tagged with an interest in sports in a subcategory of basketball. When the data store processing environment 210 receives the results at step 324, it must retrieve the entire user profile from its own data store, generate results to be presented to the user at step 326, and then output some portion of those results to the user at step 312. The advantage of placing the information in the URL saves an additional call to the database for the information needed to generate the snippet. However, it may provide some information directly in the URL which can be visible to users when the information is provided back to the user at step 312.

In another alternative, meta data information for the profile or sharing space can be included in a page title field of the HTML document generated at step 230. In this case, the document title may include additional information about the user such as the user's age, or the user's interest in basketball. The information provided in the title, an unlimited text field, may provide enough information to the data store processing environment to provide the “snippet” information back to the user processing environment.

In all aforementioned embodiments, queries to the database may be made by using any of a number of query formats, including SQL.

Subsequently, at step 312, the user may select a URL from the list of page results. When the URL is selected, at step 328, the page is constructed by the data store processing environment by the rendering engine or, as discussed below, the system of FIG. 5. At step 314 the page presented back to the user on the user processing environment 290.

FIG. 5 shows one embodiment of a system 400 for implementing the methods of FIGS. 2a, 2b, and 3. In FIG. 5, the data processing environment is represented as a trusted computing environment 400. It will be recognized that the trusted computing environment 400 may be operated by a system administrator who secures and controls access to the environment. Users seeking access to environment 400 resources may be required to pass authorization. One example of an authorization mechanism suitable for use with the sharing environment of FIG. 5 is Microsoft Passport. Other types of user authentication may alternatively be used.

Also shown is a search service processing environment 450. The search service processing environment 450 may comprise a component or be included within the trusted computing environment 400, or, as shown in FIG. 5, be provided outside of the trusted computing environment 400. Computing environments 400 and 450 include a plurality of processing devices and servers, each of which may be implementing by the processing device shown in FIG. 11.

Users interact with each processing environment 400 or 450 using one or more clients: a web client 116, a mobile client 118, a third party client application 120 or a messenger client 122. It will be understood that each of the clients 116, 118, 130 and 122 may operate on one or more processing devices including, but not limited to, the processing device shown in FIG. 11. It will be further understood that the queries for data in the trusted environment may be initiated directly with the search processing environment 450 or with the trusted computing environment 400. In the context of the description of FIG. 5, it will be assumed that the user interacts with the service interfaces 430, 432, 434, and 436.

Environment 400 includes a user data store 480 which can include user content, file storage, and other user data, a member directory 470, a data object model 440, and service interfaces 430, 432, 434, and 436. The user data store 480 contains user data which may, in one embodiment, be provided in a plurality of relational databases 486 which may be operated on by business logic 482 and accessed via a web service 484. In the sharing environment example discussed above, the data associated with the sharing environment—, for example, lists, interest categories, web logs, pictures, and the like—is contained in the user data stores 486. Data access is performed by private web services 484 via a data object model 440. Optionally, reads of binary data in the user data 486, such as pictures, can be performed via a public HTTP proxy after a separate authorization process (not shown).

Object model 440 provides an abstraction layer between the member directory and user data and the user interfaces 430, 432, 434, and 436. The data object model includes a search proxy 432 and a synthesizer 444. In one embodiment, the synthesizer 444 constructs the add and delete lists described above with respect to FIGS. 2a and 2b. The synthesizer may rely on a separate thread to both create and export the add and delete files. Once exported, each list may be flushed and the synthesizer can construct new lists in accordance with the method of FIGS. 2a and 2b. As the exports continue, new add and delete files are generated by the synthesizer 444 periodically. The search proxy 442 is a component that exposes application programming interfaces (APIs) to the search system 450. In one embodiment, the search proxy is a component that exposes APIs of the form:

SearchResultCollection GetResults(string searchText, string market, string blogName)

SearchResultCollection GetResults(string searchText, string market)

When provided with the results, the proxy constructs a search request to the search system 450 and receives an XML document with the search results (e.g. step 332). The document can be exposed via any suitable reader and mapped to a search collection object for provision to the web user interface 432 (e.g. step 326). Interfaces 432 and 434 are the primary user interfaces for users of the trusted computing environment 400. Each interface may comprise an interface server presenting an interface such as a web page to the user. Each user interface 432, 434 includes an authorization component which, in one embodiment, may be Microsoft Passport authentication.

Member directory 470 includes profile and nickname data for users of the trusted computing environment 400. Data may be associated with the unique identifier, such as a Passport unique identifier, and the data accessed through a private web service 472 with the data object model 440. Contacts and storage information 480 may also include an address book clearing house which provides role and permission information for the computing environment 400. An address book of each user's contacts and other information may be stored in the user data 486. Again, data may be based on a unique user identifier such as a passport user identifier, and data access provided via the web service 484. The MSN search proxy takes a search request from the object model client and constructs a query to the MSN search using the request to receive the XML file that contains the result.

A new and recently updated module may be included within the business logic 482. The new and recently updated module is linked to the object model and provides new and changed information referred to at step 214. Data access is through file input/output with each of the servers 486.

It will be recognized that numerous modifications of the structural configuration shown in FIG. 5 may be utilized that departing from the scope and content of the present invention

FIG. 6 shows an exemplary user interface 600 implemented in a web browser for sharing service such as that described above. As noted briefly with respect to FIG. 4, the Web browser 601 includes a standard menu of information tools that are accessible to the user of the web browser, including an address line 604 for allowing the user to enter the uniform resource locator of the sharing service. The sharing service interface includes a menu 605 which allows users of the sharing service to access various components of the service. Tabs in the menu 605 may allow the user to set up a specific user profile, enter entries in the user's web log, enter photos, enter lists, or enter music lists.

A home page, displayed in FIG. 6, may include various modules 610, 620, 630, 640, 650, 660, 670, 680 which may include different types of data which are stored in the relational database for the sharing service. Each of the modules shown is a different type of data which is stored in a relational database. A photo album module 610 includes photographic data which may be entered by the user and tagged by the user as discussed below. The music list module 620 displays a list of music which the user may enter. The archive module 630 shows archives of the user's web log shown at 680. The search space module 640 allows the user to search everything in the user's individual sharing service space. The updated spaces module 650 allows users to see other users which have recently updated their spaces. A custom list may be displayed in a module 660, allowing the user to enter information in any number of different free text formats. A profile module 670 displays a snippet of information about the user's individual profile.

Two search functions are shown in FIG. 6. One is a “search space” module 640, allowing a search for information limited to the data in the user's space. A second search interface is a search header menu 690. Menu bar 690 includes drop-down menu 692 which allows a user to focus the search keywords entered in query field 694 to all spaces, a people/spaces search, group spaces search, event spaces search, photos search, lists search, and web logs (blogs) search. Searches on people/spaces, group spaces, and event spaces can be based on keywords; searches on photos, lists, and blogs are on the words with which those items are tagged. In another embodiment, lists and web logs can be key word searched and indexed as well.

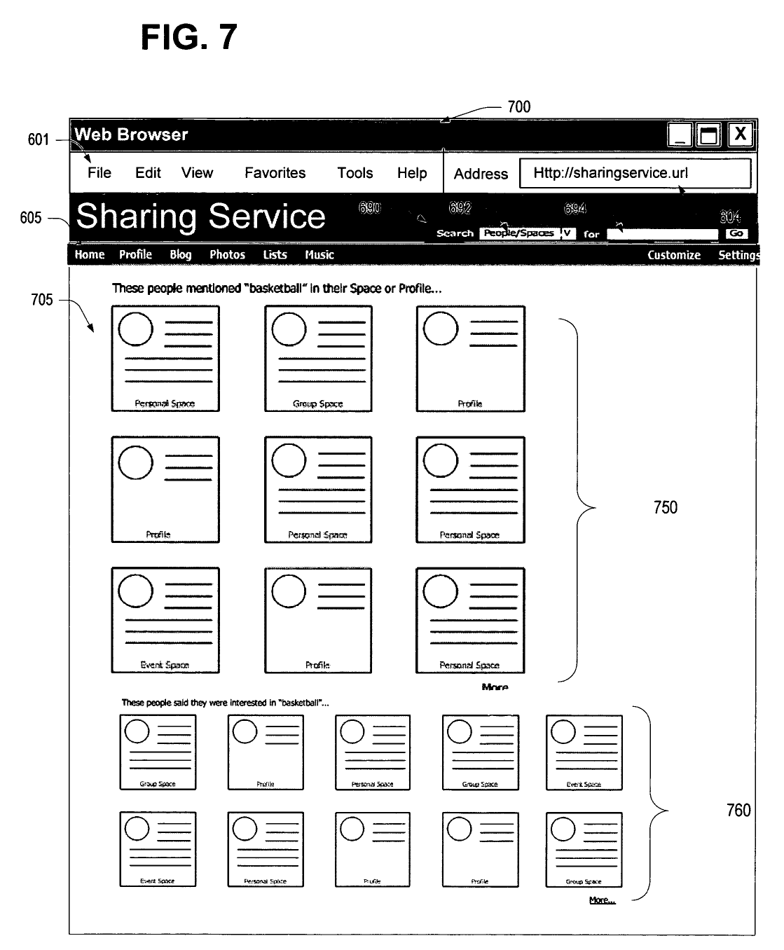

When a search performed based on a keyword, a results interface such as that shown on FIG. 7 is provided. Whether a user does a search by keyword, or a search by interests, in one embodiment the results may be run against both the keyword and the interest itself. This conversion of the type of search conducted may be performed by the search proxy 442 in accordance with the translation step 322 described with respect of FIG. 3. The keyword search results in a list of results 750 which users mentioned the term “basketball” in their profile. Result 750 is the search engine environment 450's result of the content in the sharing environment. The results set includes a mixture of different types of spaces and profiles, the result of clicking on any one of these will be to take the user to the person's profile or space. A second set of results 760 is based on the interest that the user has set up in categorizing their particular sharing environment. Again, the result includes a mixture of different types of spaces and profiles.

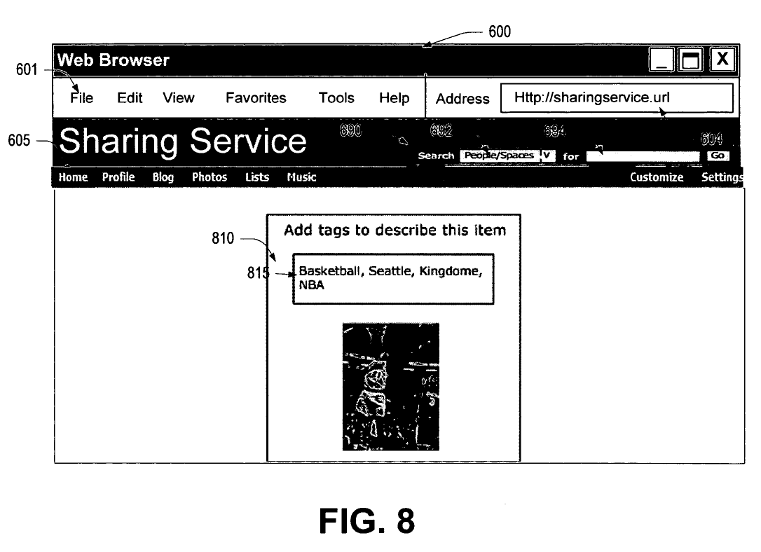

FIG. 8 shows an example of the interface 800 allowing the user to add descriptive tags to the items provided in the user sharing environment. The number and types of tags which may be supported in the tagging of data in this environment may, in one context, be up to the system administrator and include only specific tags which are supported by the search environment 450. Alternatively, they may be any key-word associations a user wishes to make with their particular data. The user interface 800 allows users to tag their profile with such predefined or self-selected categories. Currently, the sharing space may allow users to create tags of elements in the user's profile, such as a user's interests or hobbies, tagging the user's photos, exemplified in FIG. 8, tagging lists, and tagging web logs. Tags can be words or phrases, and, in the example shown in FIG. 8, are separated by any delimiter, such as commas. The photographic element 810 shown in FIG. 8 is a picture of a basketball player. Tags are added in text field 815 and include the words basketball, Seattle, Kingdome, and NBA. Users can be prompted to add tags which are simply words the user enters to describe the item separated by a comma. The item being tagged is displayed along with the tagged items.

These tags can be called by the search engine and indexed by the engine separately and apart from the keywords indexing what the search engine does. Every piece of data that can be tagged can have its own HTML page that the search engine crawls. When users tag the data, each of those tags may be incorporated into the meta tag of each HTML page generated at step 230 above. This allows queries to be run specifically against the data in this meta tag and allows the system to return all data tagged with any term the user enters whether they browse and search on via the system of the present invention. Subsequently, the users can search for or click on different tags.

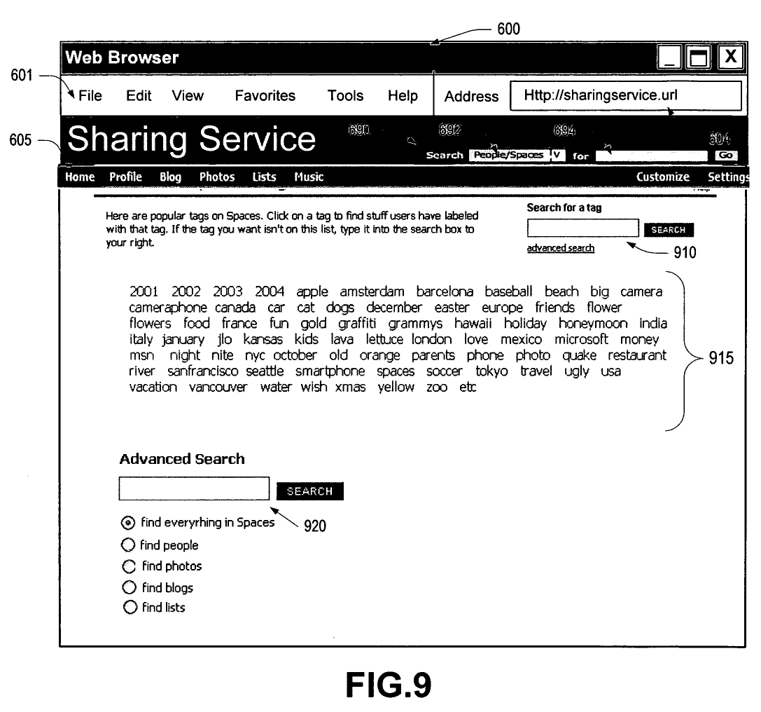

FIG. 9 shows an example of a user interface 900 allowing users to select different tags, or enter specific tagged entries in a search field 910. At 915, lists of tags which are prevalent within the sharing service are indicated. Each tag is a hyperlink which performs a search on the tag indicated in field 915. A free text entry field 910 allows users to search for specific words as tags, and an advanced search interface 920 allows users to enter query data and limit their search to specific areas, such as sharing environment, people, photos, web logs, or lists.

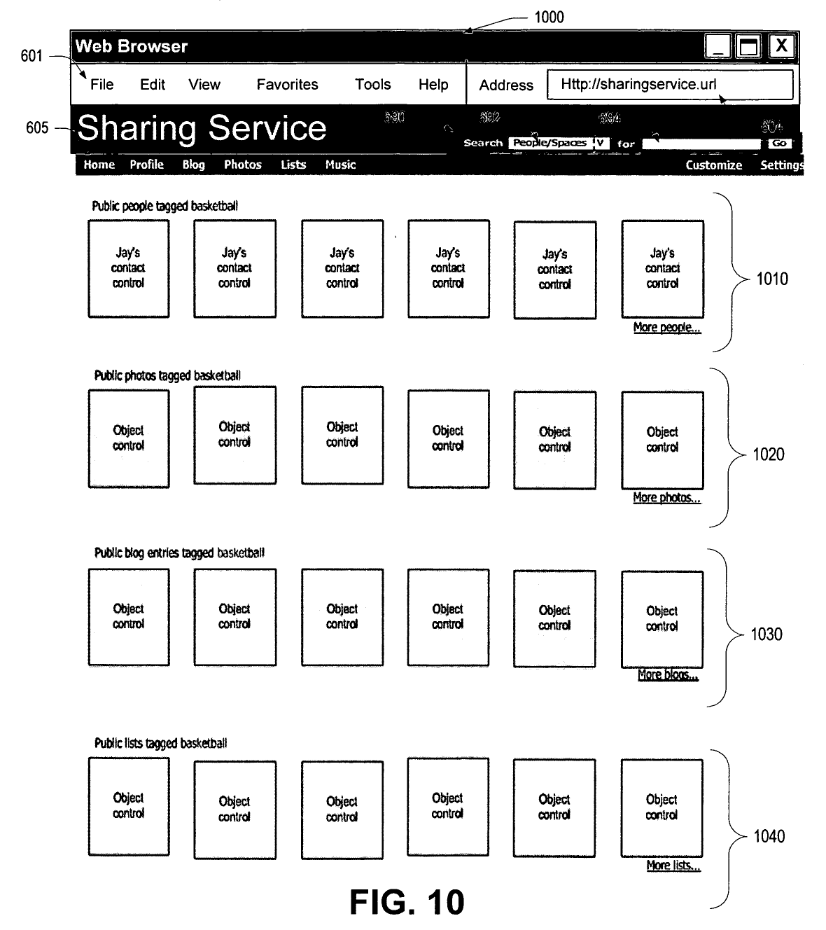

The results of the tag search can be shown in FIG. 10. FIG. 10 shows a user interface 1000 which shows four set of types of search results. Results 1010 show people that tagged basketball as an interest of one of their contacts. Results 1020 show shared photos which have been tagged with the term basketball. Results 1030 show blog entries tagged with the word basketball, and results 1040 show public lists tagged with the word basketball.

Additional considerations need to be made for security. Once the data in the shared computing environment 400 is exposed to the search engine 450, all the data, whether public or private, is exposed to the search engine. One way to allow searches on private spaces is to host another index which is not available to those users not having access to the trusted computing store 400.

FIG. 11 shows an exemplary system for implementing the invention includes a general purpose computing device in the form of a computer 1110. Components of computer 1110 may include, but are not limited to, a processing unit 1120, a system memory 1130, and a system bus 1121 that couples various system components including the system memory to the processing unit 1120. The system bus 1121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1110 typically includes a variety of computer readable media. Computer readable media can be any available media that can be accessed by computer 1110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1130 includes computer storage media in the form of volatile and/or nonvolatile memory such as read only memory (ROM) 1131 and random access memory (RAM) 1132. A basic input/output system 1133 (BIOS), containing the basic routines that help to transfer information between elements within computer 1110, such as during start-up, is typically stored in ROM 1131. RAM 1132 typically contains data and/or program modules that are immediately accessible to and/or presently being operated on by processing unit 1120. By way of example, and not limitation, FIG. 11 illustrates operating system 1134, application programs 1135, other program modules 1136, and program data 1137.

The computer 1110 may also include other removable/non-removable, volatile/nonvolatile computer storage media. By way of example only, FIG. 11 illustrates a hard disk drive 1140 that reads from or writes to non-removable, nonvolatile magnetic media, a magnetic disk drive 1111 that reads from or writes to a removable, nonvolatile magnetic disk 1112, and an optical disk drive 1115 that reads from or writes to a removable, nonvolatile optical disk 1116 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1141 is typically connected to the system bus 1121 through a non-removable memory interface such as interface 1140, and magnetic disk drive 1111 and optical disk drive 1115 are typically connected to the system bus 1121 by a removable memory interface, such as interface 1110.

The drives and their associated computer storage media discussed above and illustrated in FIG. 11, provide storage of computer readable instructions, data structures, program modules and other data for the computer 1110. In FIG. 11, for example, hard disk drive 1141 is illustrated as storing operating system 1144, application programs 1145, other program modules 1146, and program data 1147. Note that these components can either be the same as or different from operating system 1134, application programs 1135, other program modules 1136, and program data 1137. Operating system 1144, application programs 1145, other program modules 1146, and program data 1147 are given different numbers here to illustrate that, at a minimum, they are different copies. A user may enter commands and information into the computer 1100 through input devices such as a keyboard 1162 and pointing device 1161, commonly referred to as a mouse, trackball or touch pad. Other input devices (not shown) may include a microphone, joystick, game pad, satellite dish, scanner, or the like. These and other input devices are often connected to the processing unit 1120 through a user input interface 1160 that is coupled to the system bus, but may be connected by other interface and bus structures, such as a parallel port, game port or a universal serial bus (USB). A monitor 1191 or other type of display device is also connected to the system bus 1121 via an interface, such as a video interface 1190. In addition to the monitor, computers may also include other peripheral output devices such as speakers 1197 and printer 196, which may be connected through a output peripheral interface 1190.

The computer 1110 may operate in a networked environment using logical connections to one or more remote computers, such as a remote computer 1180. The remote computer 1180 may be a personal computer, a server, a router, a network PC, a peer device or other common network node, and typically includes many or all of the elements described above relative to the computer 1110, although only a memory storage device 1181 has been illustrated in FIG. 11. The logical connections depicted in FIG. 11 include a local area network (LAN) 1171 and a wide area network (WAN) 1173, but may also include other networks. Such networking environments are commonplace in offices, enterprise-wide computer networks, intranets and the Internet.

When used in a LAN networking environment, the computer 1110 is connected to the LAN 1171 through a network interface or adapter 1170. When used in a WAN networking environment, the computer 1110 typically includes a modem 1172 or other means for establishing communications over the WAN 1173, such as the Internet. The modem 1172, which may be internal or external, may be connected to the system bus 121 via the user input interface 1160, or other appropriate mechanism. In a networked environment, program modules depicted relative to the computer 1110, or portions thereof, may be stored in the remote memory storage device. By way of example, and not limitation, FIG. 11 illustrates remote application programs 1185 as residing on memory device 1181. It will be appreciated that the network connections shown are exemplary and other means of establishing a communications link between the computers may be used.

The foregoing detailed description of the invention has been presented for purposes of illustration and description. It is not intended to be exhaustive or to limit the invention to the precise form disclosed. Many modifications and variations are possible in light of the above teaching. As noted above, the invention can be used to provide a query service to any data which can be constructed by a logical operation such as an algorithm or structured lookup. In the case of an algorithm, a set of parameters could construct and object without data persistence. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for conducting a search on structured data using a text search engine, comprising:
modeling a resource accessible as a relational data as a web page;
providing a locator to the resource; and
providing the resource in a consumable format to the text search engine.

2. The method of claim 1 further including the steps of:
receiving a search on the resource;
converting the search into a converted query consumable by the search engine; and
providing the converted query to the search engine.

3. The method of claim 2 further including the steps of:
receiving a list of search results from the search engine; and
rendering a result page including the results.

4. The method of claim 3 wherein the step of receiving includes receiving a link to a group of resources, and the step of rendering includes querying the data store for the group of resources.

5. The method of claim 4 wherein the group of resources is a sharing space.

6. The method of claim 2 wherein the method further includes receiving a request for the resource; and
converting the results a format for a user agent.

7. The method of claim 1 wherein the step of providing includes the steps of:
generating a URL for each resource; and
generating a list of added, changed and deleted resources.

8. The method of claim 7 wherein the URL includes data describing the content of the resource identified by the URL.

9. The method of claim 7 further including the step of sending the list of added, changed and deleted resources to the search engine.

10. The method of claim 7 further including the step of returning the list of added, changed and deleted resources to the search engine in response to a request for pages to be crawled from the search engine.

11. The method of claim 1 wherein the data store includes a plurality of resources and at least a portion of the resources are canonicalized.

12. The method of claim 1 wherein the step of providing includes the steps of:
generating a URL for a group of resources and the URL includes data identifying one or more individual resources in the group of resources.

13. A method for rendering structured data searchable using a text search engine, comprising:
determining a modified resource in a data store;
creating a uniform resource locator for the modified resource;
providing the URL to a search crawler; and
generating a text representation of the resource in response to a query from the search crawler.

14. The method of claim 13 further including the steps of:
receiving a search query for information in the structured data;
converting the search query into format consumable by the search engine;
providing a converted query to the search engine.

15. The method of claim 14 further including the steps of:
receiving a list of search results from the search engine; and
rendering a result page including the results.

16. The method of claim 14 wherein the search query is for a data tag.

17. The method of claim 14 wherein the search query is for a keyword.

18. A method for providing key word searching of structured data, comprising:
determining a set of modified resources in a data store;
creating a uniform resource locators for the set of modified resources;
providing the uniform resource locators to a search crawler;
generating a text representation of the resource in response to a query from the search crawler; and
receiving a search query result from the search engine.

19. The method of claim 18 wherein the method further includes the step of rendering a presentation of the query result to a user interface.

20. The method of claim 18 wherein the uniform resource locator includes data identifying the resource sufficient for the rendering step to provide the query result.
